(19) United States
(12) Patent Application Publication
(10) Pub. No.: US 2025/0190320 A1
(43) Pub. Date: Jun. 12, 2025

(54) DYNAMIC COMBINATORIAL TEST DESIGN MODELING

(71) Applicant: INTERNATIONAL BUSINESS MACHINES CORPORATION, ARMONK, NY (US)

(72) Inventors: ANDREW C. M. HICKS, HIGHLAND, NY (US); DEBORAH A. FURMAN, STAATSBURG, NY (US); RYAN THOMAS RAWLINS, NEW PALTZ, NY (US); MICHAEL E. GILDEIN, WAPPINGERS FALLS, NY (US)

(21) Appl. No.: 18/532,077

(22) Filed: Dec. 7, 2023

(51) Int. Cl. G06F 11/263; G06F 11/36

(52) U.S. Cl. CPC G06F 11/263; G06F 11/3684; G06F 11/3688

(57) ABSTRACT

Dynamic Combinatorial Test Design (CTD) modeling includes querying, by a processing device, a system under test (SUT) to be tested based on a CTD model. The processing device receives, based on the querying, system configuration information including one or more system value sets each corresponding to an attribute of the CTD model. The processing device modifies the CTD model based on the received configuration information.

### BACKGROUND

The present disclosure relates to methods, apparatus, and products for dynamic Combinatorial Test Design (CTD) modeling.

### SUMMARY

According to embodiments of the present disclosure, various methods, apparatus and products for dynamic Combinatorial Test Design (CTD) modeling are described herein. In some aspects, dynamic CTD modeling includes querying, by a processing device, a system under test (SUT) to be tested based on a CTD model. The processing device receives, based on the querying, system configuration information including one or more system value sets each corresponding to an attribute of the CTD model. The processing device modifies the CTD model based on the received configuration information.

### BRIEF DESCRIPTION OF THE DRAWINGS

FIG. 1 sets forth an example computing environment according to aspects of the present disclosure.

FIG. 2 sets forth an example implementation of the Combinatorial Test Design (CTD) model modification code shown in FIG. 1 according to aspects of the present disclosure.

FIG. 3 sets forth an example CTD testing system according to aspects of the present disclosure.

FIG. 4 sets forth a flowchart of an example method for dynamic CTD modeling according to aspects of the present disclosure.

### DETAILED DESCRIPTION

Computerized devices control almost every aspect of our life, from writing documents to controlling traffic lights. However, computerized devices are error-prone, and thus require a testing phase in which the errors, or bugs, should be discovered. The testing phase is considered one of the most difficult tasks in designing a computerized device. The cost of not discovering a bug may be enormous, as the consequences of the bug may be disastrous. Additionally, a bug in hardware or firmware may be expensive to fix if it is discovered after the computerized device has shipped to customers, as patching it may require call-back of the computerized device. Hence, many developers of computerized devices invest a substantial portion of the development cycle to discover erroneous behaviors of the computerized device.

During the testing phase, a system under test (SUT) is being tested. The SUT may be, for example, a computer program, a hardware device, firmware, an embedded device, a component thereof, or the like. Testing may be performed using a test suite that includes test cases. The test suite may be reused to revalidate that the SUT exhibits a desired functionality with respect to the tests of the test suite. For example, the test suite may be reused to check that the SUT works properly after a bug is fixed. The test suite may be used to check that the bug is indeed fixed (with respect to a test that previously induced the erroneous behavior). Additionally, or alternatively, the test suite may be used to check that no new bugs were introduced (with respect to other tests of the test suite that should not be affected by the bug fix).

Some examples disclosed herein are directed to dynamic Combinatorial Test Design (CTD) modeling based on hardware platform. CTD is a testing methodology that seeks to increase test space coverage for a System Under Test (SUT) through the use of automated algorithms. These algorithms identify input patterns that are most likely to locate problems in the SUT, thereby reducing the amount of time required for a tester to build test cases and an automation framework. CTD is well-adapted for projects that require numerous variations on static input vectors to properly test various system states and logic pathways, which would otherwise be extremely cumbersome for a human tester. Despite this, CTD testing techniques suffer from various drawbacks, technical solutions to which are described herein.

In some examples, inputs to a SUT may be modeled in a CTD model as a collection of attribute-value pairs. More specifically, inputs to a SUT can be modeled as a collection of attributes, each of which is eligible to take on one or more corresponding attribute values to form attribute-value pairs. For instance, if it is assumed that four different attributes A, B, C, and D are modeled, and if it is further assumed that these attributes can take on four distinct values; three distinct values; three distinct values; and two distinct values, respectively, then the total number of unique combinations of attribute values would be 4*3*3*2=72.

In some examples, a set of CTD test vectors may be generated based on the CTD model from the test space that includes all possible combinations of attribute values. In particular, in some examples, the entire Cartesian product space that contains all possible combinations of attribute-value pairs can be reduced to a smaller set of test vectors that provides complete pairwise coverage, for example, of the test space across all attribute values. For instance, in the example introduced above, the entire Cartesian product space would include 72 different combinations of attribute values. These 72 different combinations can be reduced down to a smaller set of combinations that still provide complete pairwise coverage of the Cartesian product space. In particular, the 72 different combinations can be reduced down to 12 distinct combinations that together include every possible pairwise interaction of attribute values. It should be appreciated that a set of test vectors that provides complete m-wise coverage across the attribute values can also be generated (where m>2), but would require a greater number of test vectors that increases logarithmically as m increases.

In some examples, a corresponding set of CTD test cases are generated from the set of CTD test vectors that provides the desired amount of coverage of the test space, and the set of test cases are executed to obtain execution results (e.g., a pass or fail result for each test case). In some examples, based on the execution results, a particular test case may be selected for expansion via an inverse combinatorics technique to obtain a new set of test cases designed to detect and localize a fault in the SUT (e.g., a pairwise error that occurs as a result of the interaction of a particular combination of two different attribute values).

In some examples, the above-described process can be repeated with different sets of CTD vectors. For instance, in some examples, multiple different sets of CTD vectors that each provide complete pairwise coverage of a test space can be generated. Each such set of CTD vectors may include at least one test vector that includes a different combination of attribute values than any test vector in any other set of CTD vectors. In addition, in some examples, different sets of CTD vectors that are generated may include the same CTD vector (e.g., the same exact combination of attribute values) from which the same test case is generated. Test cases corresponding to the different sets of CTD vectors can be generated and executed, and one or more of the test cases may expose one or more faults in the SUT.

A CTD model may be written with abstract values or ranges of values that may be made into concrete values when a test case is written/generated from the CTD model. Typically, these values (or range of values) are selected based on design documentation. An issue may arise when the test case is executed on a system that is configured such that the range of concrete values does not match the range of possible values. The test case may then need to be altered or not executed because it is using values outside the system's configuration.

Some examples disclosed herein include an automated fact gathering step in the test case generation process such that before generating a concrete test case from a CTD model, the SUT is queried to identify the configuration values that are available, which in turn drives the available concrete values that can be used in the test case. The abstract values in the CTD model are turned into concrete values based on the fact gathering step in the test process to customize the actual values that can be used for each specific system. Some examples of the present disclosure are directed to a method for dynamically adjusting CTD model attributes and value sets based on system restrictions and limitations. Some examples include identifying model attributes and their associated system resources, and monitoring and identifying changes to system resources associated with one or more model attributes.

An example of the present disclosure is directed to a method for dynamic CTD modeling, which includes querying, by a processing device, a system under test (SUT) to be tested based on a CTD model. The method includes receiving, by the processing device, based on the querying, system configuration information including one or more system value sets each corresponding to an attribute of the CTD model. The method includes modifying, by the processing device, the CTD model based on the received configuration information.

Examples of the method include various technical features that yield technical effects that provide various improvements to computer technology. For instance, some examples include the technical feature of modifying, by the processing device, the CTD model based on the received configuration information. These technical features yield the technical effect of improving testing efficiency and increasing the likelihood that a set of test cases generated from the CTD model will expose a fault in a SUT. Examples disclosed herein are able to avoid issues that may arise during testing of a SUT that is configured with a range of concrete values that do not match the range of possible values in the CTD model, and avoid the need to alter or skip certain test cases because the test cases use values outside of the configuration of the SUT. These technical effects represent an improvement to debugging and fault detection computer technology by automating model modifications and increasing the efficiency and efficacy of testing.

In some examples, the CTD model in the method may model inputs to the SUT as a plurality of attributes, and each attribute may include a set of attribute values. In some examples, the method may further include identifying, by the processing device, one or more of the attributes of the CTD model that correspond to the system value sets. This has the technical effect of automatically identifying model attributes that correspond to system value sets to facilitate dynamic updating of the CTD model.

In some examples of the method, modifying, by the processing device, the CTD model, may include modifying one or more of the attribute values of the CTD model based on the received configuration information. In some examples of the method, modifying one or more of the attribute values of the CTD model may include changing abstract values in the CTD model to concrete values. This has the technical effect of dynamically updating attribute values of the CTD model based on the configuration of the SUT to increase the efficiency and efficacy of testing.

In some examples of the method, modifying, by the processing device, the CTD model, may include removing attribute values to scale down the CTD model. In some examples of the method, modifying, by the processing device, the CTD model, may include adding attribute values to scale up the CTD model. This has the technical effect of dynamically scaling the CTD model based on the configuration of the SUT to increase the efficiency and efficacy of testing.

In some examples, the method may further include receiving, by the processing device, updated system configuration information indicating a change in configuration of the SUT; and modifying, by the processing device, the CTD model based on the updated configuration information. This has the technical effect of dynamically updating the CTD model based on changes that occur to a SUT to increase the efficiency and efficacy of testing, and facilitates dynamic reprioritization of new tests based on an addition or change to the SUT.

In some examples the method may further include generating a set of test vectors based on the modified CTD model, wherein the set of test vectors provides a desired amount of coverage of a test space that includes all possible combinations of attributes values of the modified CTD model; generating, for the set of test vectors, a corresponding set of test cases; and executing the set of test cases to obtain execution results. This has the technical effect of generating test vectors and test cases using the modified CTD model to increase the efficiency and efficacy of testing. The use of the modified CTD model helps to avoid issues that may arise during testing of a SUT that is configured with a range of concrete values that do not match the range of possible values in the CTD model, and helps to avoid the need to alter or skip certain test cases because the test cases use values outside of the configuration of the SUT.

Another example of the present disclosure is directed to an apparatus for dynamic CTD modeling, which includes a processing device, and a memory operatively coupled to the processing device. The memory stores computer program instructions that, when executed, cause the processing device to query a system under test (SUT) to be tested based on a CTD model; receive, based on the query, system configuration information including one or more system value sets each corresponding to an attribute of the CTD model; and modify the CTD model based on the received configuration information.

Examples of the apparatus include various technical features that yield technical effects that provide various improvements to computer technology. For instance, some examples include the technical feature of modifying the CTD model based on the received configuration information. These technical features yield the technical effect of improving testing efficiency and increasing the likelihood that a set of test cases generated from the CTD model will expose a fault in a SUT. Examples disclosed herein are able to avoid issues that may arise during testing of a SUT that is configured with a range of concrete values that do not match the range of possible values in the CTD model, and avoid the need to alter or skip certain test cases because the test cases use values outside of the configuration of the SUT. These technical effects represent an improvement to debugging and fault detection computer technology by automating model modifications and increasing the efficiency and efficacy of testing.

In some examples, the CTD model of the apparatus may model inputs to the SUT as a plurality of attributes, and each attribute may include a set of attribute values. In some examples, the memory may store computer program instructions that, when executed, cause the processing device to identify one or more of the attributes of the CTD model that correspond to the system value sets. This has the technical effect of automatically identifying model attributes that correspond to system value sets to facilitate dynamic updating of the CTD model.

In some examples of the apparatus, modifying the CTD model may include modifying one or more of the attribute values of the CTD model based on the received configuration information. In some examples of the apparatus, modifying one or more of the attribute values of the CTD model may include changing abstract values in the CTD model to concrete values. This has the technical effect of dynamically updating attribute values of the CTD model based on the configuration of the SUT to increase the efficiency and efficacy of testing.

In some examples of the apparatus, modifying the CTD model may include removing attribute values to scale down the CTD model or adding attribute values to scale up the CTD model. This has the technical effect of dynamically scaling the CTD model based on the configuration of the SUT to increase the efficiency and efficacy of testing.

In some examples of the apparatus, the memory may store computer program instructions that, when executed, cause the processing device to: receive updated system configuration information indicating a change in configuration of the SUT; and modify the CTD model based on the updated configuration information. This has the technical effect of dynamically updating the CTD model based on changes that occur to a SUT to increase the efficiency and efficacy of testing, and facilitates dynamic reprioritization of new tests based on an addition or change to the SUT.

In some examples of the apparatus, the memory may store computer program instructions that, when executed, cause the processing device to: generate a set of test vectors based on the modified CTD model, wherein the set of test vectors provides a desired amount of coverage of a test space that includes all possible combinations of attributes values of the modified CTD model; generate, for the set of test vectors, a corresponding set of test cases; and execute the set of test cases to obtain execution results. This has the technical effect of generating test vectors and test cases using the modified CTD model to increase the efficiency and efficacy of testing. The use of the modified CTD model helps to avoid issues that may arise during testing of a SUT that is configured with a range of concrete values that do not match the range of possible values in the CTD model, and helps to avoid the need to alter or skip certain test cases because the test cases use values outside of the configuration of the SUT.

Another example of the present disclosure is directed to a computer program product for dynamic CTD modeling, comprising a computer readable storage medium, wherein the computer readable storage medium comprises computer program instructions that, when executed: query a system under test (SUT) to be tested based on a CTD model; receive, based on the query, system configuration information including one or more system value sets each corresponding to an attribute of the CTD model; and modify the CTD model based on the received configuration information.

Examples of the computer program product include various technical features that yield technical effects that provide various improvements to computer technology. For instance, some examples include the technical feature of modifying the CTD model based on the received configuration information. These technical features yield the technical effect of improving testing efficiency and increasing the likelihood that a set of test cases generated from the CTD model will expose a fault in a SUT. Examples disclosed herein are able to avoid issues that may arise during testing of a SUT that is configured with a range of concrete values that do not match the range of possible values in the CTD model, and avoid the need to alter or skip certain test cases because the test cases use values outside of the configuration of the SUT. These technical effects represent an improvement to debugging and fault detection computer technology by automating model modifications and increasing the efficiency and efficacy of testing.

In some examples, the CTD model of the computer program product may model inputs to the SUT as a plurality of attributes, and each attribute may include a set of attribute values. In some examples, modifying the CTD model may include modifying one or more of the attribute values of the CTD model based on the received configuration information. This has the technical effect of dynamically updating attribute values of the CTD model based on the configuration of the SUT to increase the efficiency and efficacy of testing.

Examples disclosed herein provide the ability to run regression buckets on any system configuration without the need to alter or remove tests, and the ability for the CTD model to self-correct based on the environment that the tests will be running in. In some examples, the true system state is used to adjust the CTD model to represent the SUT without the need for human intervention. In this way, a regression bucket can customize itself to each machine/container/virtual machine on the test floor. In some examples, dynamic reprioritization of new tests may be performed based on an addition or change to the SUT. Some examples may focus on change impact to help identify bugs early in the test run cycle.

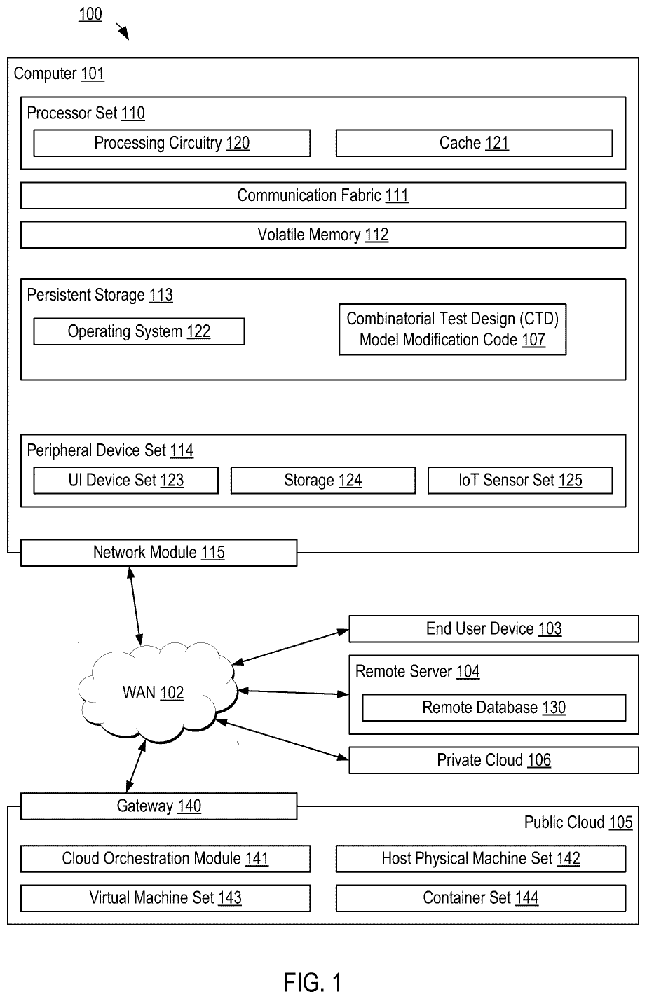

FIG. 1 sets forth an example computing environment according to aspects of the present disclosure. Computing environment 100 contains an example of an environment for the execution of at least some of the computer code involved in performing the various methods described herein, such as Combinatorial Test Design (CTD) model modification code 107. In addition to CTD model modification code 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and CTD model modification code 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in CTD model modification code 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in CTD model modification code 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

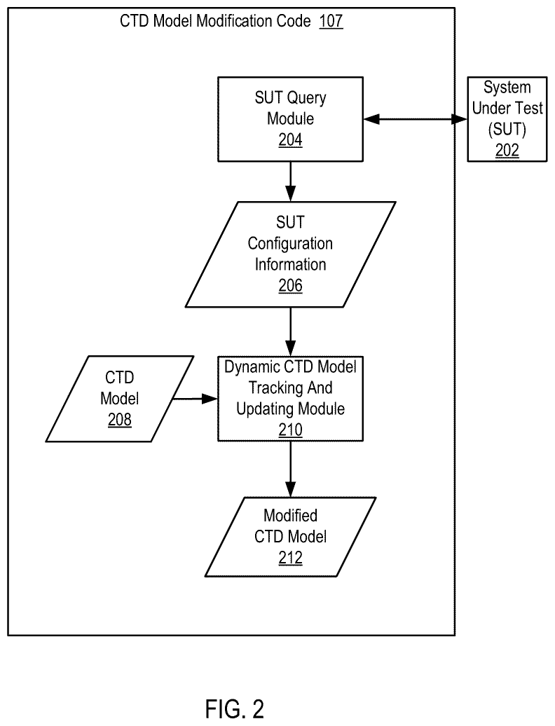

FIG. 2 sets forth an example implementation of the CTD model modification code 107 shown in FIG. 1 according to aspects of the present disclosure. FIG. 2 also shows a system under test (SUT) 202. The SUT 202 may be a hardware system, a software system, or a combination thereof. The CTD model modification code 107 includes SUT query module 204 and dynamic CTD model tracking and updating module 210. SUT query module 204 queries the SUT 202 for configuration information. In response, the SUT 202 provides SUT configuration information 206 to SUT query module 204, which provides the SUT configuration information 206 to dynamic CTD model tracking and updating module 210. SUT Configuration information 206 may include, for example, information regarding attached devices, number of CPUs, maximum number of address spaces, number of systems in a systems complex (sysplex), number of threads operating, amount of RAM, as well as other information regarding the configuration of SUT 202.

In some examples, inputs to SUT 202 may be modeled in CTD model 208 as a collection of attribute-value pairs. More specifically, inputs to SUT 202 can be modeled in CTD model 208 as a collection of attributes, each of which is eligible to take on one or more corresponding attribute values to form attribute-value pairs. The CTD model 208 can include a set of attributes, a respective domain of possible values for each attribute, and restrictions on the value combinations across attributes. In some examples, one or more of the attributes in CTD model 208 are functional attributes of a SUT. The functional attributes may be any attribute of the SUT, such as the examples of configuration information listed above (e.g., information regarding attached devices, number of CPUs, maximum number of address spaces, number of systems in a sysplex, number of threads operating, amount of RAM, etc.). Each item of information in the SUT configuration information 206 may correspond to a particular attribute in the CTD model 208.

Based on the received SUT configuration information 206, CTD model tracking and updating module 210 modifies CTD model 208 to generate a modified CTD model 212. For example, if CTD model 208 states that the number of processes can range from 1 to 10, but SUT 202 is configured with only 8, the CTD model 208 may then be customized (or it may customize itself) into modified CTD model 212 and only pick from a range of 1 to 8 when generating the concrete test program. A regression test bucket may then become self-aware of the environment in which it is to be executed in and adjust accordingly. Concrete values for the abstract values in the CTD model 208 may be determined from the fact gathering step performed by SUT query module 204, such as running 5-10 processes in parallel while checking the system management facility (SMF) log. If the SUT 202 is currently running 8 processes, the concrete value, 8, is used in the modified CTD model 212 and for the test case, rather than killing or spinning up an extra process. This fits the parameter of the test while working within the existing construct of the machine being tested, and speeds up the testing process.

Abstract attribute values in the CTD model 208 may be turned into concrete values based on the fact gathering step performed by SUT query module 204 to customize the actual values that can be used for each specific SUT. The modification of the CTD model 208 to create the modified CTD model 212 may include removing attribute values, adding attribute values, modifying a set of attribute values into a modified set of attribute values, and modifying a range of attribute values into a modified range of attribute values. In this manner, the CTD model 208 may be automatically scaled up or scaled down based on the configuration of the current SUT. When attribute values are added to the CTD model 208, they may be prioritized to the top. The abstract values may take the form of (min, med, max), for example, and then based on the hardware environment of the SUT, these abstract values may dynamically take on different values.

In some examples, CTD model modification code 107 is incorporated into the CTD model 208 so that the CTD model 208 is configured to detect its environment and scale itself up or down accordingly into a modified CTD model 212. This allows CTD model 208 to optimize its performance and ensure that it is operating within the limits of the hardware and software it is running on. One of the benefits of this feature is that missing input/output (I/O) channels may be automatically eliminated. This means that if CTD model 212 requires a specific I/O channel to function, but that channel is not present in the environment it is running on, the CTD model 212 will detect this and eliminate that channel automatically. This helps to reduce false positive errors and ensure that the CTD model 212 is functioning correctly.

In some examples, CTD model 208 automatically implements range limits. For example, if CTD model 208 requires a certain amount of RAM to function properly, but the SUT 202 it is running on does not have enough RAM, the CTD model 208 may automatically scale down to operate within the available RAM. This helps to prevent crashes and other performance issues that can occur when a model is operating beyond the range of available resources.

In cases where the CTD model 208 includes more resources than the SUT 202 it is running on, such as in the case of a CTD model 208 requiring 64G of RAM but the SUT 202 only has 32G of RAM, the excess resources may be automatically omitted. This helps to ensure that the CTD model 208 operates within the available resources of the SUT 202, preventing crashes and other issues that can occur when a model exceeds the available resources.

In some examples, CTD model 208 also has the ability to detect its environment and scale up accordingly. If a SUT 202 has more resources available than the CTD model 208 requires, the CTD model 208 can automatically scale up to take advantage of the additional resources. This helps to improve performance and optimize the model's functionality.

However, when new channels are added, it is important to consider how this should be handled. Depending on the nature of the channel and the impact it has on the model's functionality, additional testing may be required to ensure that the model is still functioning correctly. Similarly, if more memory is configured, it may be necessary to increase the range limits to ensure that the model is operating within the available resources. It may also be important to alert clients when new tests are needed to verify system stability. This helps to ensure that any changes to the model's environment or resources are thoroughly tested and that any issues are identified and addressed before they can impact the system's stability or performance.

Overall, the ability for CTD model 208 to detect its environment and scale up or down accordingly is a feature that helps to optimize performance, prevent errors, and ensure that the CTD model 208 is operating within the available resources of the SUT 202. Some examples of the present disclosure involve determining a minimum number of test cases on a client's system to optimize the CTD model 208 based on system updates of adding or removing hardware. Some examples involve analyzing the performance difference of the CTD model 208 before and after a hardware change (e.g., prior to running any new test cases) and using that as input to further minimize the number of test cases that need to be run to optimize model performance. In some examples, an optimal set of test cases may be run in-situ using the client's model without the need for separate testing to determine the optimal resource allocations. This would mean no downtime for the client, and they only see slight differences in performance or maybe see an error and need to retry while the test cases are being run, but they do not have to pause operation completely to run a separate set of tests.

Some examples of the present disclosure include pre-generating a representative set of test cases to execute based on the available CTD model 208 at that instance in time. The dynamic adaptation of the CTD model 208 based on resources currently available will then process the remaining queue of test cases for applicability to the current dynamically adjusted CTD model 208 to remove and/or add test cases as appropriate. Some examples involve iteratively generating test cases from a given CTD model 208, such that a call can be made to a model processor to generate the next test case when desired. This allows for a more efficient use of resources when the CTD model 208 will be dynamically adapting to the system resources. The adaptation for the CTD model 208 can be invoked by a multitude of triggers including, but not limited to, software events, hardware events, and/or temporal polling.

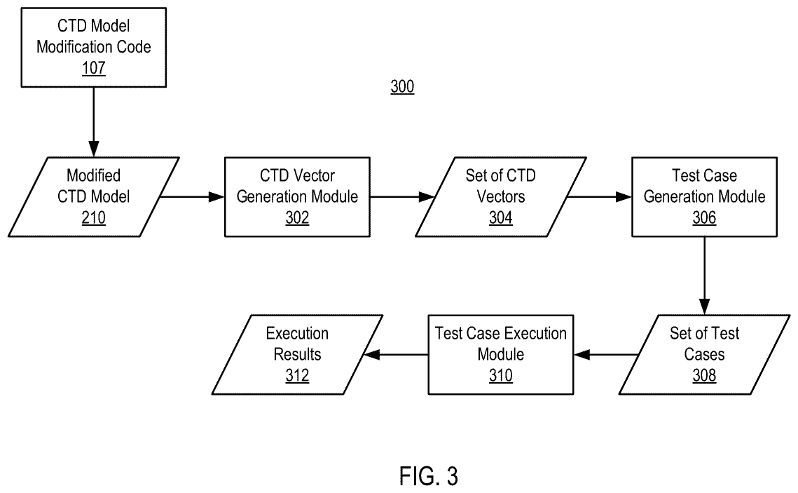

FIG. 3 sets forth an example CTD testing system 300 according to aspects of the present disclosure. CTD testing system 300 includes CTD model modification code 107, CTD vector generation module 302, test case generation module 306, and test case execution module 310. It is noted that each of the modules 302, 306, and 310 may be implemented with one or more modules. Inputs to a SUT (e.g., SUT 202) are modeled in modified CTD model 210 as a collection of attribute value pairs. Any number of attributes may be used to model SUT inputs, and each attribute may take on any number of candidate attribute values. Computer-executable instructions of CTD vector generation module 302 are executed to generate a reduced set of CTD vectors 304 that provides a desired amount of coverage (e.g., complete pairwise coverage) of a Cartesian product space associated with the collection of attribute-value pairs. The reduced set of CTD vectors 304 may include a significantly lesser number of combinations of attribute values than are present in the Cartesian product space, but may nonetheless provide the desired amount of coverage of the Cartesian product space (e.g., complete pairwise coverage). In example embodiments, a binary decision diagram or the like may be used to perform the reduction and identify the set of CTD vectors 304 that provides the desired amount of coverage (e.g., complete pairwise coverage).

Computer-executable instructions of test case generation module 306 may be executed to generate, from the set of CTD test vectors 304, a corresponding set of test cases 308. For instance, the set of CTD test vectors 304 may be provided as input to a test case generation tool such as a test case template that is configured to generate a respective corresponding test case for each CTD vector. Each test case in the set of test cases 308 may be designed to test the interactions among the particular combination of attribute values represented in a corresponding CTD vector of the set of CTD vectors 304. A set of CTD test vectors and their corresponding test cases may, at times herein, be described and/or depicted interchangeably.

Computer-executable instructions of test case execution module 310 may be executed to execute the set of test cases 308 and generate execution results 312. In some examples, based on the execution results 312 from executing the set of test cases 308, one or more of the test cases may expose a fault in the SUT (e.g., a pairwise error that occurs as the result of the interaction of a particular combination of two different attribute values). In some examples, the above-described process may be repeated with different sets of CTD test vectors.

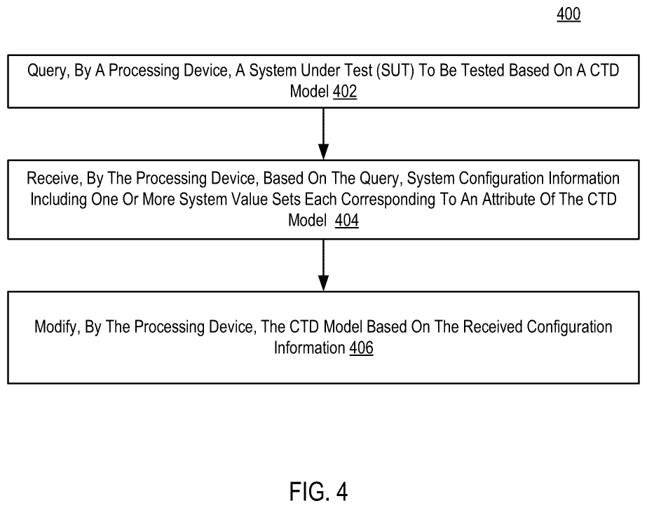

FIG. 4 sets forth a flowchart of an example method 400 for dynamic CTD modeling according to aspects of the present disclosure. In a particular embodiment, the method 400 of FIG. 4 is performed utilizing the CTD model modification code 107. The method 400 of FIG. 4 includes querying 402, by a processing device, a system under test (SUT) to be tested based on a CTD model. The method 400 includes receiving 404, by the processing device, based on the querying, system configuration information including one or more system value sets each corresponding to an attribute of the CTD model. The method 400 includes modifying 406, by the processing device, the CTD model based on the received configuration information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for dynamic Combinatorial Test Design (CTD) modeling, comprising:
querying, by a processing device, a system under test (SUT) to be tested based on a CTD model;
receiving, by the processing device, based on the querying, system configuration information including one or more system value sets each corresponding to an attribute of the CTD model; and
modifying, by the processing device, the CTD model based on the received configuration information.

2. The method of claim 1, wherein the CTD model models inputs to the SUT as a plurality of attributes, and wherein each attribute includes a set of attribute values.

3. The method of claim 2, and further comprising:
identifying, by the processing device, one or more of the attributes of the CTD model that correspond to the system value sets.

4. The method of claim 2, wherein modifying, by the processing device, the CTD model, includes modifying one or more of the attribute values of the CTD model based on the received configuration information.

5. The method of claim 4, wherein modifying one or more of the attribute values of the CTD model includes changing abstract values in the CTD model to concrete values.

6. The method of claim 2, wherein modifying, by the processing device, the CTD model, includes removing attribute values to scale down the CTD model.

7. The method of claim 2, wherein modifying, by the processing device, the CTD model, includes adding attribute values to scale up the CTD model.

8. The method of claim 1, and further comprising:
receiving, by the processing device, updated system configuration information indicating a change in configuration of the SUT; and
modifying, by the processing device, the CTD model based on the updated configuration information.

9. The method of claim 1, and further comprising:
generating a set of test vectors based on the modified CTD model, wherein the set of test vectors provides a desired amount of coverage of a test space that includes all possible combinations of attributes values of the modified CTD model;
generating, for the set of test vectors, a corresponding set of test cases; and
executing the set of test cases to obtain execution results.

10. An apparatus for dynamic Combinatorial Test Design (CTD) modeling, comprising:
a processing device; and
memory operatively coupled to the processing device, wherein the memory stores computer program instructions that, when executed, cause the processing device to:
query a system under test (SUT) to be tested based on a CTD model;
receive, based on the query, system configuration information including one or more system value sets each corresponding to an attribute of the CTD model; and
modify the CTD model based on the received configuration information.

11. The apparatus of claim 10, wherein the CTD model models inputs to the SUT as a plurality of attributes, and wherein each attribute includes a set of attribute values.

12. The apparatus of claim 11, wherein the memory stores computer program instructions that, when executed, cause the processing device to:
identify one or more of the attributes of the CTD model that correspond to the system value sets.

13. The apparatus of claim 11, wherein modifying the CTD model includes modifying one or more of the attribute values of the CTD model based on the received configuration information.

14. The apparatus of claim 13, wherein modifying one or more of the attribute values of the CTD model includes changing abstract values in the CTD model to concrete values.

15. The apparatus of claim 11, wherein modifying the CTD model includes removing attribute values to scale down the CTD model or adding attribute values to scale up the CTD model.

16. The apparatus of claim 10, wherein the memory stores computer program instructions that, when executed, cause the processing device to:
receive updated system configuration information indicating a change in configuration of the SUT; and
modify the CTD model based on the updated configuration information.

17. The apparatus of claim 10, wherein the memory stores computer program instructions that, when executed, cause the processing device to:
generate a set of test vectors based on the modified CTD model, wherein the set of test vectors provides a desired amount of coverage of a test space that includes all possible combinations of attributes values of the modified CTD model;
generate, for the set of test vectors, a corresponding set of test cases; and
execute the set of test cases to obtain execution results.

18. A computer program product for dynamic Combinatorial Test Design (CTD) modeling, comprising a computer readable storage medium, wherein the computer readable storage medium comprises computer program instructions that, when executed:
query a system under test (SUT) to be tested based on a CTD model;
receive, based on the query, system configuration information including one or more system value sets each corresponding to an attribute of the CTD model; and
modify the CTD model based on the received configuration information.

19. The computer program product of claim 18, wherein the CTD model models inputs to the SUT as a plurality of attributes, and wherein each attribute includes a set of attribute values.

20. The computer program product of claim 19, wherein modifying the CTD model includes modifying one or more of the attribute values of the CTD model based on the received configuration information.
